(19) United States
(12) Patent Application Publication
(10) Pub. No.: US 2006/0197307 A1
(43) Pub. Date: Sep. 7, 2006

(54) Supports and support systems for wheeled vehicles

(76) Inventor: David Dubbe, Yorktown, VA (US)

Correspondence Address: KRAMER & AMADO, P.C., Suite 240, 1725 Duke Street, Alexandria, VA, 22314, US

(21) Appl. No.: 11/071,219

(22) Filed: Mar. 4, 2005

(51) Int. Cl. B62J 25/00

(52) U.S. Cl. 280/291

(57) ABSTRACT

A support and support system for a wheeled vehicle, for improved support and comfort, steerage and control. The support or support system includes a knee support 20 having at least one load-bearing knee-contact capable of supporting the knee of a rider. The load-bearing knee-contact is fastened to the wheeled vehicle. In combination with at least one other load-bearing contact, the load-bearing knee-contact is capable of supporting the rider on the wheeled vehicle.

### FIELD OF THE INVENTION

This invention relates to supports for a rider of a wheeled vehicle, in particular knee supports and support systems. This invention also relates to wheeled vehicles with supports and support systems, for improved support and comfort, steerage and control.

### BACKGROUND OF THE INVENTION

Typically, riders of wheeled vehicles such as motorcycles (e.g., sports bikes), suffer from poor positioning and lack of support when in riding position. On a sports bike, for example, riders are normally supported by a seat, handlebar and foot pegs, wherein the rider's shoulders are centered over the knees, thereby increasing the center of mass and load that must be absorbed at the feet, wrists and hands. Under braking conditions, where the force of both vehicle and rider are thrown forward, the load exerted at the wrists and hands, and thus the handlebar (i.e., steering mechanism), is increased even further. Moreover, when carrying a passenger, the exerted load is even greater.

Certain solutions, however, have been proposed in the art with respect to improving rider comfort and vehicle control. In U.S. Pat. No. 5,447,116, a watercraft is provided with a seat, leg areas, and knee areas, so that the operator may kneel or crouch, thereby providing a lower center of gravity and more sporting control. In U.S. Pat. No. 5,857,747, a truck is provided with at least one knee rest and a seat, thereby taking a load off of the driver's knee joints and spinal column. In U.S. Pat. No. 1,753,826, a knee grip is disposed between the knee of a rider and the motorcycle gasoline tank. Similarly, in application US 2004/0035624, a driver may apply pressure to one of the leaning pads in the vicinity of the knees, when the driver wants to lean to a particular side of a three-wheeled vehicle.

Nevertheless, various deficiencies exist with the currently proposed solutions. It is noted in particular that no solution provides for improved support and comfort, steerage and control, in a wheeled vehicle, in particular in a wheeled vehicle where the steering mechanism is configured for both load-bearing and vehicle control.

Accordingly, these and other deficiencies are addressed by the present invention. With the present invention, a wheeled vehicle may be improved with respect to support and comfort, steerage and control, wherein the exerted load is reduced, thereby providing for improved stability, load-bearing, weight distribution, cornering and braking. Support and comfort, steerage and control, may also be improved via load reduction at the wrists and hands, thereby providing for improved dexterity with hand controls as concerns cornering, steering, braking, clutching and accelerating.

### SUMMARY OF THE INVENTION

The present invention relates to supports for a rider of a wheeled vehicle, for improved comfort, steerage and control. The present invention also relates to knee supports and support systems for riders of wheeled vehicles. The present invention further relates to wheeled vehicles with supports and support systems.

In a preferred embodiment, the present invention relates to a knee support for a wheeled vehicle, the knee support comprising at least one load-bearing knee-contact, wherein the knee-contact is capable of supporting the knee of a rider; the knee-contact being fastened to the wheeled vehicle; wherein in combination with at least one load-bearing hand-contact, the knee-contact is capable of supporting the rider on the wheeled vehicle.

In a preferred embodiment, the present invention relates to a wheeled vehicle having a knee support system, the wheeled vehicle including the knee support system, the knee support system comprising a knee support having at least one load-bearing knee-contact, wherein the knee-contact is capable of supporting a knee of a rider; wherein the knee-contact is fastened to the wheeled vehicle.

In another preferred embodiment, the present invention relates to a support system for a wheeled vehicle, the support system comprising a plurality of load-bearing contacts including at least one load-bearing knee-contact and at least one load-bearing hand-contact; wherein the knee-contact is capable of supporting a knee of a rider, the knee-contact being fastened to the wheeled vehicle; wherein in combination with the hand-contact, the knee-contact is capable of supporting the rider on the wheeled vehicle.

In another preferred embodiment, the present invention relates to a support system for a motorcycle, the support system comprising a plurality of load-bearing contacts including at least one load-bearing knee-contact, wherein the knee-contact is capable of supporting a knee of a rider; wherein the knee-contact is fastened to the motorcycle.

In a further preferred embodiment, the present invention relates to a wheeled vehicle having a support system, the wheeled vehicle including the support system, wherein the support system comprising a plurality of load-bearing contacts including at least one load-bearing knee-contact, wherein the knee-contact is capable of supporting a knee of a rider; wherein the knee-contact is fastened to the wheeled vehicle.

### BRIEF DESCRIPTION OF THE DRAWINGS

FIG. 1 is a top view of a knee support according to a preferred embodiment of the present invention.

FIG. 2 is side view of a knee support according to a preferred embodiment of the present invention.

FIG. 3 is a side view of a motorcycle with a knee support according to a preferred embodiment of the present invention.

FIG. 4 is another side view of a motorcycle with a knee support according to a preferred embodiment of the present invention.

FIG. 5 is a side view of a knee support according to a preferred embodiment of the present invention.

FIG. 6 is a top view of a motorcycle with a knee support according to a preferred embodiment of the present invention.

FIG. 7A is a side view illustration of loads on a motorcycle having a knee support according to a preferred embodiment of the present invention.

FIG. 7B is another side view illustration of loads on a motorcycle having a knee support according to a preferred embodiment of the present invention.

FIG. 8A is a side view illustration of loads on a motorcycle without a knee support according to the present invention.

FIG. 8B is another side view illustration of loads on a motorcycle with a knee support according to a preferred embodiment of the present invention.

### DETAILED DESCRIPTION OF PREFFERED EMBODIMENTS

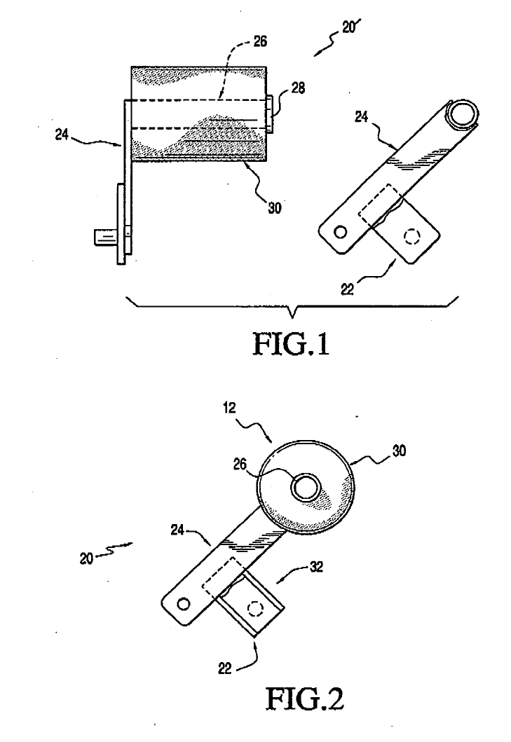

With reference to the drawings, in particular FIGS. 1-8, the present invention may be described in preferred embodiments as a support for a wheeled vehicle 10.

With reference to the drawings, in particular FIGS. 1 and 2, a preferred embodiment of a knee support 20 generally comprises at least one load-bearing knee-contact 12, wherein the knee-contact 12 is capable of supporting the knee of a rider. In combination with at least one load-bearing hand-contact 14, the knee-contact 12 is capable of supporting the rider on the wheeled vehicle 10. The knee support 20 may also be fastened to the wheeled vehicle 10.

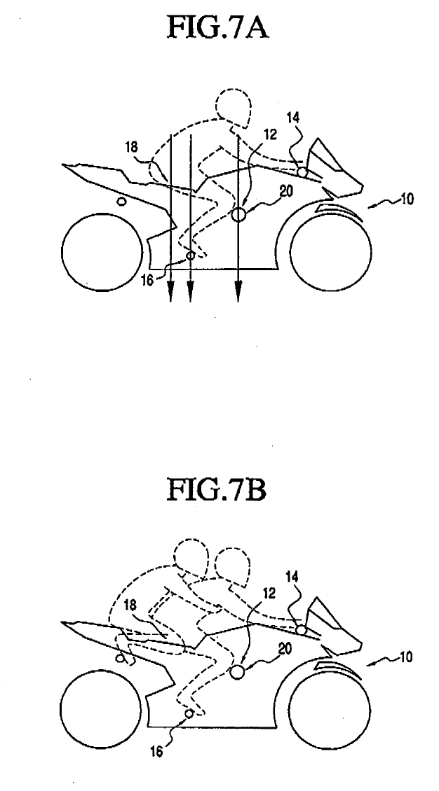

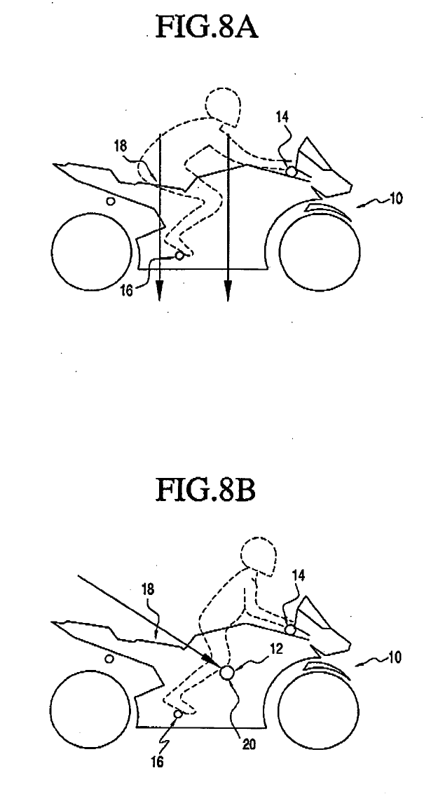

With reference in particular to FIGS. 7A, 7B and 8B, a preferred embodiment of a support system for a wheeled vehicle 10 generally comprises a plurality of load-bearing contacts. The load-bearing contacts include at least one load-bearing knee-contact 12 and at least one load-bearing hand-contact 14, wherein the knee-contact 12 is capable of supporting a knee of a rider. In combination with the hand-contact 14, the knee-contact 12 is capable of supporting the rider on the wheeled vehicle 10. This knee support 20 may also be fastened to the wheeled vehicle 10.

With reference in particular to FIGS. 7A, 7B and 8B, a preferred embodiment of a wheeled vehicle 10 having a knee support system generally comprises a knee support 20 including at least one load-bearing knee-contact 12. The knee-contact 12 is capable of supporting a knee of a rider. The knee support 20 may also be fastened to the wheeled vehicle 10.

With reference in particular to FIGS. 7A, 7B and 8B, a preferred embodiment of a support system for a motorcycle generally comprises a plurality of load-bearing contacts. The plurality of load-bearing contacts includes at least one load-bearing knee-contact 12, wherein the knee-contact 12 is capable of supporting a knee of a rider. The knee-contact 12 may also be fastened to the motorcycle.

With reference in particular to FIGS. 7A, 7B and 8B, a preferred embodiment of a wheeled vehicle 10 having a support system generally comprises a support system which includes a plurality of load-bearing contacts. The plurality of load-bearing contacts includes at least one load-bearing knee-contact 12, wherein the knee-contact 12 is capable of supporting a knee of a rider. The knee-contact 12 may also be fastened to the wheeled vehicle 10.

It will be understood that in the present invention, a wheeled vehicle 10 is a vehicle having at least one wheel. It will be further understood that a variety of wheeled vehicles 10, for instance motorcycles such as sport bikes, ATV's, three-wheelers, and so on, may be suitable for use with the present invention. Preferably, the wheeled vehicle 10 is a motorcycle, more preferably a sport bike or street motorcycle.

In the present invention, by load-bearing contact, it is meant a part of a vehicle which, in normal operation, bears a load exerted by the rider, thereby supporting the rider on the vehicle. As can be seen from the various embodiments of FIGS. 4, 7A, 7B and 8B, where the vehicle is a motorcycle or sports bike, the foot-pegs, seat and handlebar are all load-bearing contacts, in that they bear a load exerted by the rider, thereby supporting the rider on the vehicle. It is to be understood that different vehicles may have a variety of load-bearing contacts, in accordance with the present invention. It will be understood, however, that the primary purpose of a load-bearing contact is rider support during normal operation of the vehicle.

In preferred embodiments, the load-bearing hand-contact 14 of the present invention is any load-bearing contact which supports the hands, and preferably the wrists, of a rider, as shown in FIGS. 4, 7A, 7B and 8B. A variety of load-bearing hand-contacts 14 are envisaged as suitable for use in the present invention, although a handlebar is preferred, as also shown in FIGS. 4, 7A, 7B and 8B. Those of ordinary skill in the art will understand that in addition to providing support for a rider, a load-bearing hand-contact 14 may also work to provide steerage and control for the vehicle, for example with hand controls for braking, clutching and accelerating, cornering and steering.

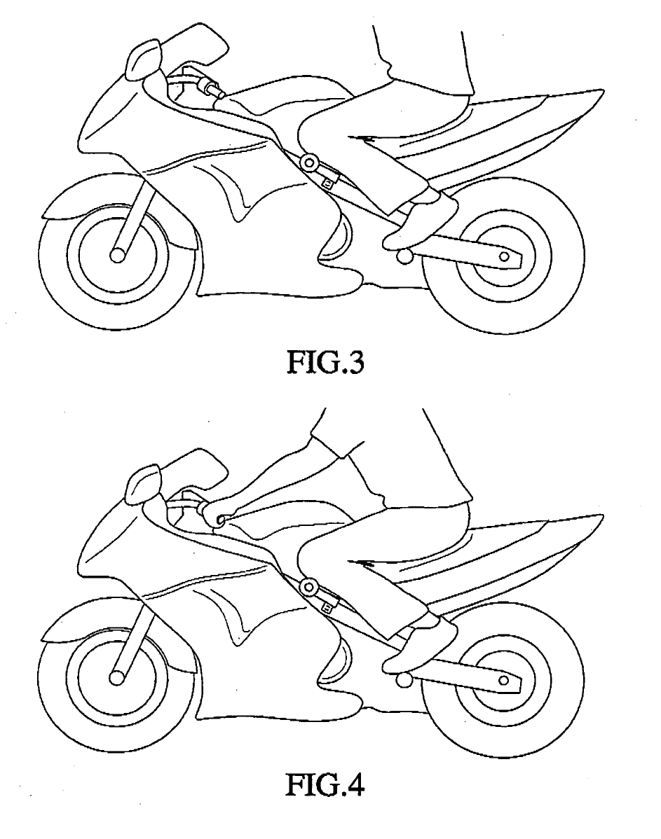

In preferred embodiments, the load-bearing foot-contact 16 of the present invention is any load-bearing contact which supports the foot of a rider. A variety of load-bearing foot-contacts 16 are envisaged as suitable for use in the present invention, for example a foot-peg, footboard, and so on, depending on the type of vehicle. As shown in FIGS. 3, 4, 7A, 7B and 8B, a foot-peg is preferred as the load-bearing foot-contact 16, in particular where the vehicle is a motorcycle.

In preferred embodiments, the load-bearing seat-contact 18 of the present invention is any load-bearing contact which supports the underside of a rider. A variety of load-bearing seat-contacts 18 are envisaged as suitable for use in the present invention, for instance depending on the type of vehicle. However, where the vehicle is a sports bike, a seat as typically found on a motorcycle is preferred, as shown in FIGS. 3, 4, 7A, 7B and 8B.

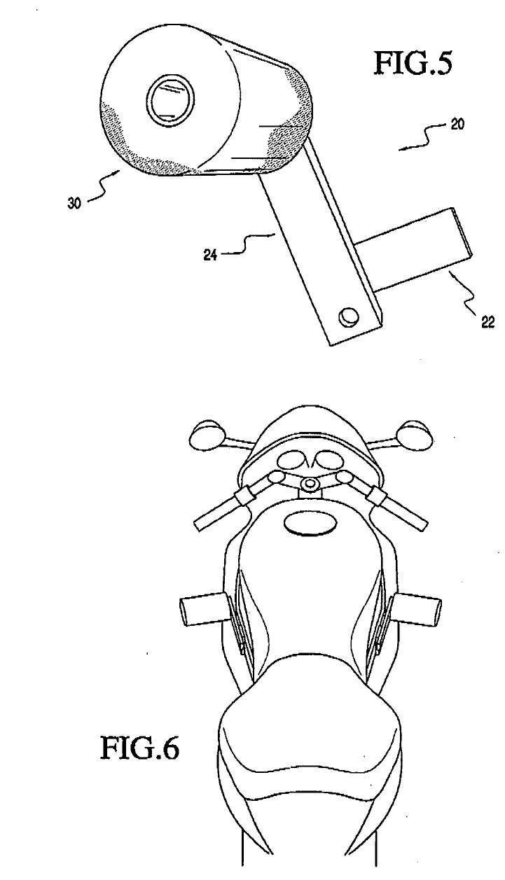

With reference in particular to FIGS. 1-6, 7A-7B and 8B, it may be seen that the knee support 20 of the present invention includes a load-bearing knee-contact 12. In preferred embodiments, the load-bearing knee-contact 12 of the invention is a load-bearing contact which supports the knee of a rider during normal operation. Preferably, the rider rests a portion of the leg, for example a portion of the leg between the knee and foot, against at least one load-bearing knee-contact 12, so that the knee-contact 12 is capable of supporting the knee of the rider. More preferably, the rider rests a portion of the knee against at least one load-bearing knee-contact 12, so that the knee-contact 12 is capable of supporting the knee of the rider. It is envisioned that a variety of configurations of such a load-bearing knee-contact 12 will be suitable for use in the invention. For example, a load-bearing knee-contact 12 is preferably configured as a padded or unpadded peg, more preferably as a padded or unpadded bar, more preferably as a padded round bar, as seen for example in FIGS. 2 and 5. Moreover, the knee support 20 of the present invention preferably includes a fastening mechanism for fastening the knee support 20 (and the knee-contact 12), to a frame of the wheeled vehicle 10. In a preferred embodiment, the knee support 20 (and the knee-contact 12) is fastened to a fairing (e.g., a motorcycle fairing), wherein the fairing is connected to the frame of the wheeled vehicle 10. Those of ordinary skill in the art will understand that the load-bearing knee-contact 12 is configured so that the rider rests a knee on the contact, which thereby supports the rider's weight and load, and thus the rider on the vehicle.

With reference to FIGS. 1, 2 and 5, the knee support 20 of the present invention may be further described in preferred embodiments. In a first preferred embodiment, as illustrated in FIGS. 1 and 5, the knee support 20 includes first 22 and second 24 pieces of metal fastened together at right angles, and a round bar 26 (e.g., ¾ inch round bar) fastened at a right angle and perpendicular to the second 24 piece of metal. In fastening the knee support 20 to a wheeled vehicle 10 (e.g., a motorcycle), the first piece of metal 22 may be fastened to the vehicle frame, while the second piece of metal 24 rests along the side of the frame. Those of ordinary skill in the art will understand that a variety of techniques, for example welding, bolting, clamping, forming, casting, molding, and so on, may be used for fastening in the present invention, for instance fastening the round bar 26 and second piece of metal 24, fastening the first 22 and second 24 pieces of metal, or fastening the knee support 20 to a vehicle frame. Where desirable, a cap 28 may be used to enclose an opening at the end of the round bar 26, as in FIG. 1. In addition, the round bar 26 may be covered with a padding material 30, as in FIG. 5, for improved appearance and rider comfort.

In a second preferred embodiment, as illustrated in FIG. 2, the knee support 20 includes a second piece of metal 24 fastened (e.g., via welding) to first 22 and third 32 pieces of metal, and a round bar 26 (e.g., ¾ inch round bar) fastened at a right angle and perpendicular to the second piece of metal 24. In fastening the knee support 20 to a wheeled vehicle 10 (e.g., a motorcycle), the first 22 and third 32 pieces of metal are fastened to a peg, preferably a steel foot peg attached to the vehicle frame. Again, those of ordinary skill in the art will understand that a variety of fastening techniques may be used for fastening in the present invention. Where desirable, a cap 28 may enclose an opening at the end of the round bar 26, whereas the round bar 26 may be covered with a padding material 30.

In further describing preferred embodiments of the present invention, those of ordinary skill in the art will understand that the knee support 20 may be included as part of a support system for a wheeled vehicle 10. Such a support system may include a variety of load-bearing contacts for supporting the weight and load exerted by a rider. Preferably, such load-bearing contacts include a seat-contact 18, foot-contact 16 and/or hand-contact 14, as typically found on a motorcycle (e.g., sports bike), as well as a knee-contact 12, as illustrated in FIGS. 7A, 7B and 8B. Accordingly, those of ordinary skill in the art will understand that in a support system of the invention, it is preferred that in combination with at least one load-bearing hand-contact 14, load-bearing foot-contact 16 and/or load-bearing seat-contact 18, the knee-contact 12 is capable of supporting the rider on the wheeled vehicle 10. This is more clearly seen with reference to FIG. 4, wherein a combination of load-bearing hand-contact 14, foot-contact 16, seat-contact 18 and knee-contact 12 bear the weight and load of the rider, the combination thereby supporting the rider on a motorcycle.

The present invention may be further understood with respect to the loads exerted by a rider on a wheeled vehicle 10 (e.g., a motorcycle) during operation, with further reference to FIGS. 7A-7B and 8A-8B. As illustrated in FIG. 8A, when operating a motorcycle (e.g., a sports bike), a rider's shoulders are centered over the knees, thus creating a large center of mass and load, which is absorbed at the seat and feet and, of more concern, at the wrists and hands, thereby causing discomfort and impeding control of the vehicle. This load absorption is more pronounced when the motorcycle is operated with multiple riders, for instance a driver and a passenger, as illustrated in FIG. 7B. This load absorption is even more pronounced under braking conditions, whether with a single or multiple riders, as illustrated in FIG. 8B.

However, as illustrated in FIGS. 7A, 7B and 8B, a knee support 20 may be included on a motorcycle for improved support of a rider. By providing further support for the load exerted by the rider, comfort, steerage and control may be improved. In providing a further load-bearing contact (i.e., knee-contact 12), the knee support 20 assists in reducing the load on the remaining load-bearing contacts, thereby improving rider comfort. More important, by providing a further load-bearing contact (i.e., knee-contact 12), the load exerted in particular at the wrists and hands is reduced. By reducing the load at the wrists and hands, the load on the handlebar (i.e., hand-contact 14) is reduced, thereby allowing for greater control and more efficient turning of the motorcycle.

Moreover, as illustrated in FIG. 7B, multiple riders result in an even greater load being exerted on all load-bearing contacts, in particular the load-bearing hand-contact 14. Accordingly, in multiple rider situations, rider comfort, in particular driver comfort, may be even further improved through the additional load-bearing provided by a knee support 20. Moreover, control and steerage may be further improved, where a knee support 20 is included to relieve the increased load at the load-bearing hand contact.

With further reference to FIG. 8B, those of ordinary skill in the art will understand that under braking conditions, there is an increase in downward force or load, and thus load absorption, in particular by a driver's wrists and hands, is also increased. Accordingly, the additional load-bearing provided by a knee support 20 may provide not only increased comfort, but also improved control and steerage, by reducing the load exerted on the handlebar (i.e., hand-contact) through the wrists and hands.

While there has been disclosed herein what is considered to be certain preferred embodiments of the present invention, it will be understood by those of ordinary skill in the art that various changes and modifications may be made therein without departing from the scope of the appended claims.

Accordingly, the foregoing disclosure is not intended or to be construed to limit the present invention or otherwise exclude any such other embodiments, adaptations, variations, modifications and equivalent arrangements.

The disclosure of all references cited herein are hereby incorporated by reference in their entirety.

What is claimed is:

1. A knee support for a wheeled vehicle, said knee support comprising:
at least one load-bearing knee-contact, wherein the knee-contact is capable of supporting the knee of a rider; the knee-contact being fastened to said wheeled vehicle;
wherein in combination with at least one load-bearing hand-contact, the knee-contact is capable of supporting the rider on said wheeled vehicle.

2. The knee support of claim 1, wherein said wheeled vehicle is a two-wheeled vehicle.

3. The knee support of claim 2, wherein said two-wheeled vehicle is a motorcycle.

4. The knee support of claim 1, wherein the load-bearding hand-contact is a handlebar.

5. The knee support of claim 1, wherein in further combination with at least one load-bearing foot-contact or load-bearing seat-contact, the knee-contact is capable of supporting the rider on said wheeled vehicle.

6. The knee support of claim 1, wherein the knee-contact is forward of the knee of the rider.

7. The knee support of claim 1, wherein the knee-contact is forward of at least one load-bearing foot-contact of said wheeled vehicle.

8. The knee support of claim 1, wherein the knee-contact is vertically above at least one load-bearing foot-contact of said wheeled vehicle.

9. The knee support of claim 1, wherein said knee support comprises a fastening mechanism for fastening the knee-contact to a frame of said wheeled vehicle.

10. A wheeled vehicle having a knee support system, said wheeled vehicle including said knee support system, said knee support system comprising:
at least one load-bearing knee-contact,
wherein the knee-contact is capable of supporting a knee of a rider;
wherein the knee-contact is fastened to said wheeled vehicle.

11. The wheeled vehicle of claim 10, wherein the wheeled vehicle is a two-wheeled vehicle.

12. The wheeled vehicle of claim 11, wherein the two-wheeled vehicle is a motorcycle.

13. The wheeled vehicle of claim 10, wherein in combination with at least one load-bearing hand-contact, the knee-contact is capable of supporting the rider on said wheeled vehicle.

14. The wheeled vehicle of claim 13, wherein the load-bearding hand-contact is a handlebar.

15. The wheeled vehicle of claim 10, wherein in combination with at least one load-bearing foot-contact or load-bearing seat-contact, the knee-contact is capable of supporting the rider on said wheeled vehicle.

16. The wheeled vehicle of claim 10, wherein the knee-contact is forward of the knee of the rider.

17. The wheeled vehicle of claim 10, wherein the knee-contact is forward of at least one load-bearing foot-contact of said wheeled vehicle.

18. The wheeled vehicle of claim 10, wherein the knee-contact is vertically above at least one load-bearing foot-contact of said wheeled vehicle.

19. The wheeled vehicle of claim 10, wherein said knee support comprises a fastening mechanism for fastening the knee-contact to a frame of said wheeled vehicle.

20. A support system for a wheeled vehicle, said support system comprising:
a plurality of load-bearing contacts including at least one load-bearing knee-contact and at least one load-bearing hand-contact;
wherein the knee-contact is capable of supporting a knee of a rider, the knee-contact being fastened to said wheeled vehicle;
wherein in combination with the hand-contact, the knee-contact is capable of supporting the rider on said wheeled vehicle.

21. The support system of claim 20, wherein said wheeled vehicle is a two-wheeled vehicle.

22. The support system of claim 21, wherein said two-wheeled vehicle is a motorcycle.

23. The support system of claim 20, wherein the load-bearding hand-contact is a handlebar.

24. The support system of claim 20, wherein in combination with at least one load-bearing foot-contact or load-bearing seat-contact, the knee-contact is capable of supporting the rider on said wheeled vehicle.

25. The support system of claim 20, wherein the knee-contact is forward of the knee of the rider.

26. The support system of claim 20, wherein the knee-contact is forward of at least one load-bearing foot-contact of said wheeled vehicle.

27. The support system of claim 20, wherein the knee-contact is vertically above at least one load-bearing foot-contact of said wheeled vehicle.

28. The support system of claim 20, wherein said support system comprises a fastening mechanism for fastening the knee-contact to a frame of said wheeled vehicle.

29. A support system for a motorcycle, said support system comprising:
a plurality of load-bearing contacts including at least one load-bearing knee-contact,
wherein the knee-contact is capable of supporting a knee of a rider;
wherein the knee-contact is fastened to said motorcycle.

30. The support system of claim 29, wherein in combination with at least one load-bearing hand-contact, the knee-contact is capable of supporting the rider on said motorcycle.

31. The support system of claim 30, wherein the load-bearding hand-contact is a handlebar.

32. The support system of claim 29, wherein in combination with at least one load-bearing foot-contact or a load-bearing seat-contact, the knee-contact is capable of supporting the rider on said motorcycle.

33. The support system of claim 29, wherein the knee-contact is forward of the knee of the rider.

34. The support system of claim 29, wherein the knee-contact is forward of at least one load-bearing foot-contact of said motorcycle.

35. The support system of claim 29, wherein the knee-contact is vertically above at least one load-bearing foot-contact of said motorcycle.

36. The support system of claim 29, wherein said support system comprises a fastening mechanism for fastening the knee-contact to a frame of said motorcycle.

37. A wheeled vehicle having a support system, said wheeled vehicle including said support system, wherein said support system comprises:
a plurality of load-bearing contacts including at least one load-bearing knee-contact,
wherein the knee-contact is capable of supporting a knee of a rider;
wherein the knee-contact is fastened to said wheeled vehicle.

38. The wheeled vehicle of claim 37, wherein the wheeled vehicle is a two-wheeled vehicle.

39. The wheeled vehicle of claim 38, wherein the two-wheeled vehicle is a motorcycle.

40. The wheeled vehicle of claim 37, wherein in combination with at least one load-bearing hand-contact, the knee-contact is capable of supporting the rider on said wheeled vehicle.

41. The wheeled vehicle of claim 40, wherein the load-bearding hand-contact is a handlebar.

42. The wheeled vehicle of claim 37, wherein in further combination with at least one load-bearing foot-contact or load-bearing seat-contact, the knee-contact is capable of supporting the rider on said wheeled vehicle.

43. The wheeled vehicle of claim 37, wherein the knee-contact is forward of the knee of the rider.

44. The wheeled vehicle of claim 37, wherein the knee-contact is forward of at least one load-bearing foot-contact of said wheeled vehicle.

45. The wheeled vehicle of claim 37, wherein the knee-contact is vertically above at least one load-bearing foot-contact of said wheeled vehicle.

46. The wheeled vehicle of claim 37, wherein said support system comprises a fastening mechanism for fastening the knee-contact to a frame of said wheeled vehicle.
